(19) United States
(12) Patent Application Publication
(10) Pub. No.: US 2018/0341275 A1
(43) Pub. Date: Nov. 29, 2018

(54) PRODUCT DISTRIBUTION SYSTEM

(71) Applicant: Walmart Apollo, LLC, Bentonville, AR (US)

(72) Inventor: Nicholas R. Antel, Springdale, AR (US)

(21) Appl. No.: 15/987,104

(22) Filed: May 23, 2018

Related U.S. Application Data
(60) Provisional application No. 62/509,946, filed on May 23, 2017.

(51) Int. Cl. G05D 1/02; G06Q 50/28; B65G 57/03; H04W 4/021

(52) U.S. Cl. CPC G05D 1/0276; G06Q 50/28; B62D 53/00; H04W 4/021; G05D 2201/0216; B65G 57/03

(57) ABSTRACT

In some embodiments, apparatuses and methods are provided herein useful to streamline a product distribution process, including unloading, loading, and storage. In some embodiments, a trailer is described herein that initiates communications with a facility so that it can be determined whether the trailer has products intended for delivery to the facility. Further, the trailer can scan an interior thereof to maintain an accurate inventory. In several embodiments, the trailer, facility, and guided vehicles/machines at the facility can autonomously interact to unload products from the trailer, load products into the trailer, and store the trailer, as desired.

### CROSS-REFERENCE TO RELATED APPLICATION

This application claims the benefit of the following U.S. Provisional Application No. 62/509,946 filed May 23, 2017, which is incorporated herein by reference in its entirety.

### TECHNICAL FIELD

This invention relates generally to product distribution systems and, more particularly, to interacting components for a product distribution system.

### BACKGROUND

Products can be distributed throughout a supply chain using delivery vehicles and trailers. One type of trailer that is commonly used with delivery trucks is a forty foot trailer with walls of a relatively thin, sheet metal. A trailer of this size may have too much space for smaller deliveries, such as to small format stores that require fewer products to operate. Further, such a configuration can require that the trailer be lifted by ropes or chains secured to the side and/or bottom of the trailer. Due to this, when trailers having this configuration are stored, the trailers typically are stored side-by-side, which can require a sizable amount of storage space. For locations without enough storage space, the trailer can be sent to other locations for storage, which can waste resources.

### BRIEF DESCRIPTION OF THE DRAWINGS

Disclosed herein are embodiments of systems, apparatuses and methods pertaining to product distribution systems and trailers therefor. This description includes drawings, wherein:

FIG. 1 is a system diagram in accordance with some embodiments.

FIG. 2 is aside elevational, cross-sectional view of a trailer in accordance with several embodiments.

FIG. 3 is a top plan view of a trailer in accordance with some embodiments.

FIG. 4 is a side elevational view of a crane and trailers configured to be stacked on one another by the crane in accordance with several embodiments.

FIG. 5 is a diagrammatic view of an electronic assembly in accordance with some embodiments.

FIG. 6 is a flowchart in accordance with several embodiments.

FIG. 7 is a flowchart in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for a product delivery and storage system. The system utilizes interacting components to streamline the product distribution process, including intake, loading, and storage.

In some embodiments, a trailer is described herein that initiates communications with a facility so that it can be determined whether the trailer has products intended for delivery to the facility. Further, the trailer can scan an interior thereof to maintain an accurate inventory. In several embodiments, the trailer, facility, and guided vehicles/machines at the facility can autonomously interact to unload products from the trailer, load products into the trailer, and store the trailer, as desired.

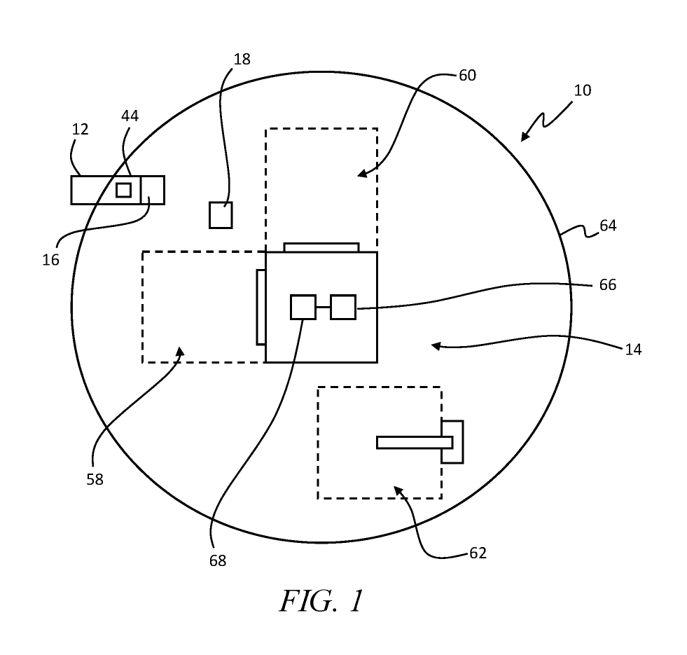

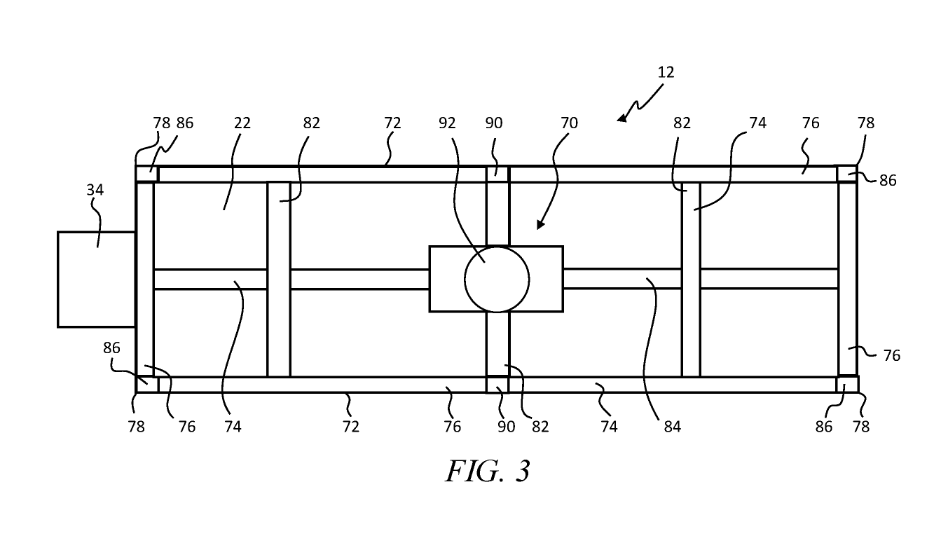

A system 10 providing these advantages is shown in FIGS. 1-7. The system 10 includes a trailer 12 interacting with a facility 14, which can be a product distribution facility, storage facility, store, and so forth. The trailer 12, as described in more detail below, is configured to be towed by a delivery vehicle 16, such as a truck, tractor, or the like, as well as by an automatic guided vehicle (AGV) 18 operating within the facility 14.

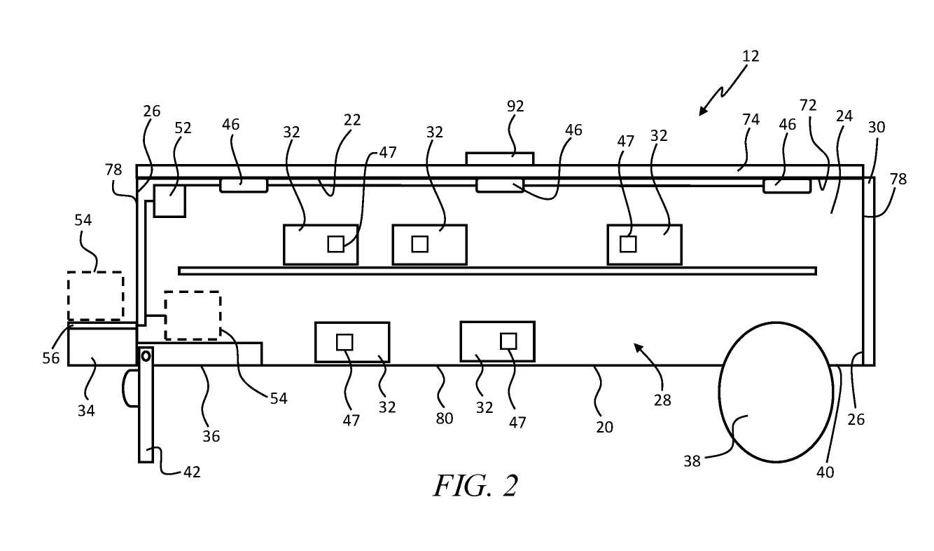

Example structure for the trailer 12 is shown in FIG. 2. In this form, the trailer 12 includes a bottom wall 20, a top wall 22, side walls 24, and end walls 26 enclosing an interior 28 thereof. The trailer 12 can further include pivoting or rolling doors 30 in or as the end wall 26 and/or side walls 24 so that a user can easily access products 32 in the interior 28 thereof. For transportation purposes, the trailer 12 further includes a coupling mechanism 34 at a front end 36 thereof configured to couple the trailer 12 to the delivery vehicle 16 and the AGV 18 so that the trailer 12 can be safely towed thereby. The coupling mechanism 34 can have any suitable configuration.

The trailer 12 also includes one or more wheel assemblies 38 mounted in or adjacent to the bottom wall 20 thereof. Each wheel assembly 38 is understood to include any and all suitable components as commonly configured. By one approach, the trailer 12 can include wheel assemblies 38 at both the front end 36 and a rear end 40 thereof. By another approach, the trailer 12 includes a wheel assembly 38 at the rear end 40 thereof, relying on the delivery vehicle 16 or AGV 18 to support the front end 36 thereof during transportation. In this form, to maintain the trailer 12 in a generally horizontal orientation when it is decoupled from the delivery vehicle 16 or the AGV 18, the trailer 12 can further include supports or legs 42 that extend downwardly from the bottom wall 20. The supports 42 are preferably sized to generally match the height of the wheel assembly 38. By one approach, as shown in FIG. XX, the supports 42 can be pivotable between a stored position extending generally along and parallel to the bottom wall 20 of the trailer 12 and a user position extending downwardly from and generally perpendicular to the bottom wall 20. Further, the supports 42 can be spring-loaded or otherwise biased to the use position, but configured to be held in the stored position when the trailer 12 is coupled to the delivery vehicle 16 or AGV 18. So configured, when the delivery vehicle 16 or AGV 18 decouples from the trailer 12, the supports 42 automatically pivot to the use position to support the trailer 12.

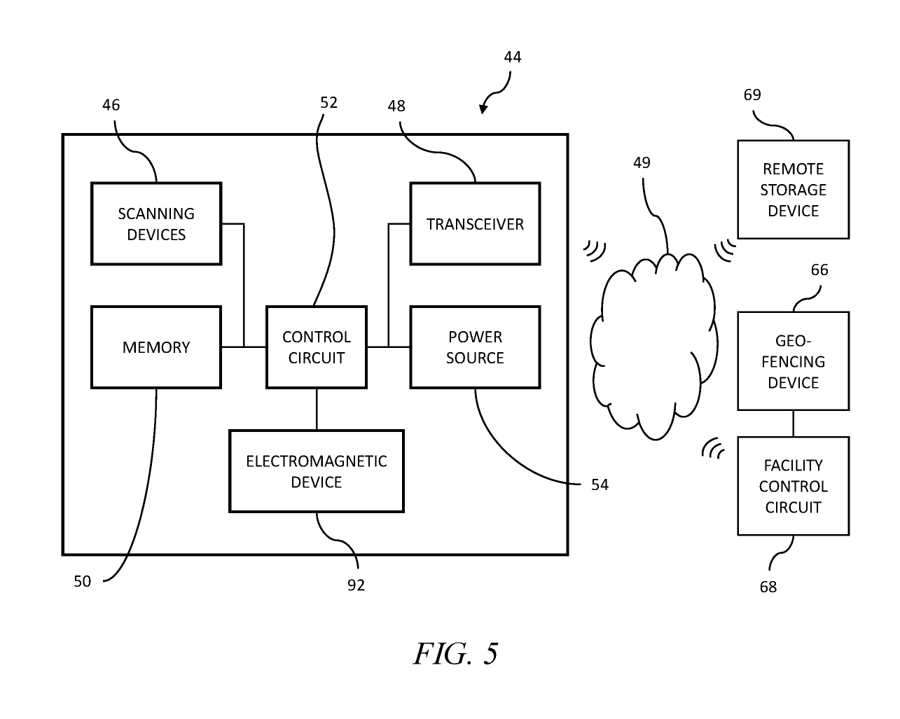

As shown in FIG. 5, the trailer 12 further includes an electronic assembly 44. The electronic assembly 44 includes one or more scanning devices 46 configured to scan the products 32 within the interior 28 thereof for identification purposes, a transceiver 48 configured to allow the trailer 12 to communicate with other device over any suitable communication network 49, including radio, Wi-Fi, Bluetooth, near field communication, and so forth, a memory 50, and a control circuit 52 configured to control operation of the electronic assembly 44. The scanning devices 46 can take any suitable form. For example, the scanning devices 46 can be radio frequency identification (RFID) readers configured to read RFID tags 47 of the products 32 to thereby identify the products 32 within the trailer interior 28. In another example, the scanning devices 46 can be cameras or other electronic imagers configured to capture images or video of the trailer interior 28 and the products 32 therein. In other examples, the scanning devices 46 can utilize infrared, sonar, laser measurement, and so forth. Thereafter, the control circuit 52 can be configured to analyze the images or video, using any suitable analysis software, to identify the products 32 in the interior 28. In another example, the scanning devices can be laser scanners configured to identify products 32 in the interior 28, by scanning machine readable codes, such as QR or UPC codes, for example.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuits described herein may be configured (for example, by using corresponding programming stored in a memory as will be well understood by those skilled in the art) to carry out one or more of the steps, actions, and/or functions described herein.

The electronic assembly 44 is further provided power by a power source 54. By one approach, the power source 54 can be disposed within the trailer 12 in any desirable location and configuration. By another approach, the power source 54 can be a power source 54 of or mounted to the delivery vehicle 16 and AGV 18. In such a case, power can be supplied from the delivery vehicle 16 and AGV 18 to the trailer electronic assembly 44 when the trailer 12 is coupled thereto. For example, the coupling mechanism 34 can include a power supply connection 56 to connect the power source 54 to the electronic assembly 44. This configuration advantageously allows the trailer 12 to have electronic components, but not require the maintenance and replacement required of a separate power supply.

Turning now to details of the facility 14, which are shown in FIG. 1. In some forms, the facility 14 can include a loading area 58, an unloading area 60, and a storage area 62. The areas 58, 60, 62 are shown separately for clarity purposes, but can be combined as desired. Further, the areas 58, 60, 62 can take any desired form, including within a building, covered, uncovered, and so forth. The loading area 58 is configured to receive one or more trailers 12 therein so that the trailers 12 can be loaded with products 32 from the facility 14. The unloading area 60 is configured to receive one or more trailers 12 therein to remove products 32 from the trailer interior 28 for delivery to the facility 14. The loading and unloading tasks can be can be autonomously performed by suitable machines. The storage area 62 is configured to receive one or more trailers 12 therein for storage purposes until the trailers 12 are needed for a subsequent delivery.

Encompassing the facility 14 is a geofencing boundary or area 64 created by a geofencing device 66 located within the facility 14 that is controlled by a facility control circuit 68. The geofencing device 66 creates the area 64 by sending out a signal therefrom that includes identification information to thereby identify the facility 14 to any receiving devices.

So configured, when the delivery vehicle 16 tows the trailer 12 within range of the geofencing device 66 to an edge or within the geofencing area 64, the transceiver 48 receives the signal from the geofencing device 66 and the control circuit 52 analyzes the identification information in the signal to identify the facility 14. The control circuit 52 then reviews the inventory list of the products 32 in the interior 28 thereof. The control circuit 52 can cause the scanning devices 46 to scan the interior 28 in response to reception of the geofencing signal, at the beginning of the trip, on demand, and/or can be configured to periodically scan the interior 28. The control circuit 52 then determines whether any of the products 32 contained therein are intended for delivery to the facility 14, such as by reference to supply chain or shipping data. The supply chain and/or shipping data is stored in the local memory 50, on a remote storage device 69, such as a server or database, and/or by querying the facility 14.

The delivery vehicle 16 can tow the trailer 12 into the facility area 64 and decouple therefrom to allow the facility to control future movement of the trailer 12. The trailer control circuit 52 transmits one or more signals to the facility 14 to identify the trailer 12 to the facility 14 and provide an indication of whether the trailer 12 includes products 32 intended for delivery to the facility 14. The signal(s) can further include shipment information including arrival, departure, and travel information, and storage location information. The facility control circuit 68 can analyze the signal and identification information of the trailer 12 to determine whether the facility 14 has products 32 intended for loading onto the trailer 12, as well as a schedule for the trailer 12. Thereafter, the control circuit 52 can task an AGV 18 to tow the trailer 12 to desired areas and the AGV 18 can autonomously tow the trailer 12 to desired locations.

For example, if the trailer 12 has products 32 intended for delivery to the facility 14, the facility control circuit 68 commands an AGV 18 to tow the trailer 12 to the unloading area 60. If the facility 14 has products 32 that are scheduled to be loaded onto the trailer 12, the facility control circuit 68 commands an AGV 18 to tow the trailer 12 to the loading area 58. Next, if the trailer 12 does not have an immediate next delivery location, the control circuit 68 can command an AGV 18 to tow the trailer 12 to the storage area 62. These actions, if applicable to a given trailer 12, can be performed in any desired order. For example, if the trailer 12 has perishable goods, the trailer 12 can be unloaded first. In another example, the trailer 12 can be stored for a period before loading additional products 32 from the facility. Of course, if desired, the delivery vehicle 16 can tow the trailer 12 directly to desired areas 58, 60, 62.

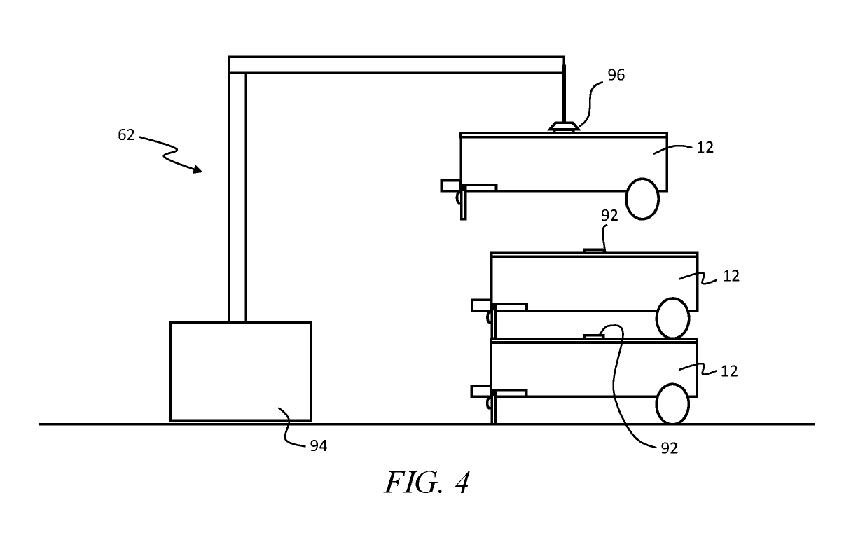

An example storage area 62 is shown in FIGS. 1 and 4. In order to more efficiently store the trailers 12, by some approaches, the trailers 12 can be configured to stack on one another. Conventional trailers can be made out of thin sheet metal material that requires that the trailers be lifted by attaching ropes or chains to the side and/or along the bottom of the trailer because lifting from the top could damage the trailer.

In contrast, the trailer 12 shown in FIG. 4 can advantageously be lifted by a portion of the top wall 22 thereof, enabling easy, efficient storage. More specifically, the trailer 12 can be configured to be lifted by a central portion 70 of the top wall 22 spaced from edges 72 thereof. To protect the trailer 12 against damage, the top wall 22 can include one or more bracing members 74 extending thereacross between the edges 72 thereof. The edges 72 of the top wall 22 can be relatively stronger than the central portion 70 of the top wall 22 by virtue of the connection of the top and side walls 22, 24 and/or by virtue of added edge bracing members 76. So configured, the trailer 12 can be lifted by the central portion 70 thereof and the bracing members 74 distribute the forces therealong to the edges 72 and down to the more structurally strong portions of the trailers, including other edges 78 between the side walls 24 and edges 80 between the side walls 24 and bottom wall 20. In the illustrated form, the trailer 12 includes three transverse bracing members 82 extending generally transverse to the length of the trailer 12 and a longitudinal bracing member 84 extending along the length of the trailer 12. Further, the trailer 12 can include support beams 86 extending vertically along the side walls 24 the edges or corners 78 thereof and, if desired, one or more intermediate support beams 90 between the edges or corners 78 thereof.

By one approach, the trailer 12 can further include an electromagnet device 92 mounted to the top wall 22 at a generally central location thereof, both longitudinally and transversely between the edges 72. Preferably, the electromagnet device 92 is mounted to the bracing members 74. The electromagnet device 92 allows the trailer 12 to be easily detachably connected to a crane 94 to be lifted so that the trailer 12 can be positioned and stacked in desired locations. As shown in FIG. 4, the storage area 62 of the facility can include the crane 94 so that the trailers 12 can be easy stacked within the area 62. The crane 94 includes a corresponding electromagnet device 96 configured to releasably couple to the electromagnet device 92 of the trailer 12.

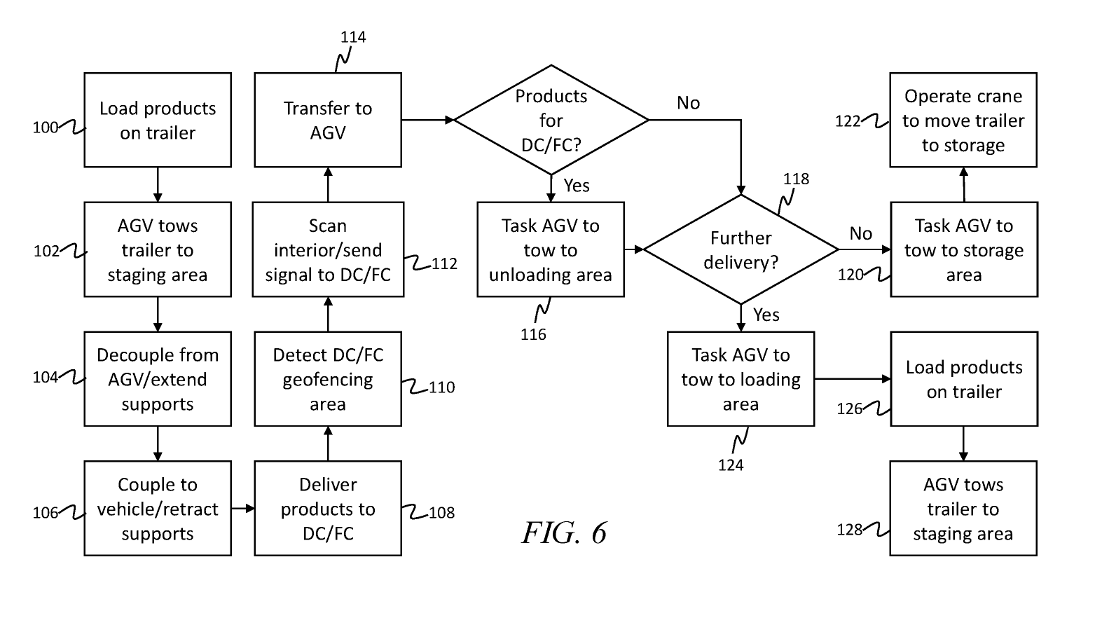

So configured, the system 10 can be utilized to increase throughput in a distribution chain, especially to smaller format stores. A flowchart showing a possible distribution chain flow for a trailer 12 as configured herein is shown in FIG. 6. In block 100, the products 32 are loaded onto the trailer 12. Thereafter, in block 102 the AGV 18 tows the trailer 12 to a staging area and in block 104 decouples therefrom. If utilizing the biased supports 42, the supports 42 automatically pivot downwardly to the use position as the AGV 18 uncouples and moves away from the trailer 12. In block 106, the delivery vehicle 16 couples to the trailer 12, which can include automatically retracting the supports 42 by pivoting the supports 42 to the stored position. In block 108, the delivery vehicle 16 tows the trailer to the planned facility 14, which can be a distribution center, fulfillment center, store, and so forth. In block 110, after the trailer 12 enters the geofencing area 64 of the facility 14 and the electronic assembly 44 thereof detects the geofencing signal broadcasted by the geofencing device 66. In block 112, the trailer control circuit 52 can operate the scanning device 46 to can the trailer interior 28 to identify the products 32 therein. Of course, other scanning times and configurations, as set forth above can also be utilized. Once the trailer control circuit 52 knows the products 32 in the trailer 12, the control circuit 52 can cause a signal to be transmitted to the facility control circuit 68 that indicates whether the trailer 12 has products 32 intended for delivery to the facility 14. In block 114, in the opposite situation as above, the delivery vehicle 16 decouples from the trailer 12 and the AGV 18 couples to the trailer 12 in a suitable area at the facility 14. In block 116, if the trailer 12 has products 32 intended for delivery to the facility 14, the facility control circuit 68 tasks the AGV 18 with towing the trailer 12 to the unloading area 60. Thereafter, or if the trailer 12 does not have products 32 intended for delivery to the facility 14, in block 118, the facility control circuit 68 or the trailer control circuit 52 determines if the trailer 12 is scheduled for a delivery to another facility. If no, in block 120, the facility control circuit 68 tasks the AGV 18 with towing the trailer 12 to the storage area 62. Then, in block 122, the crane 94 can be operated to place the trailer 12 in a desired storage location as described above. If yes, in block 124, the facility control circuit 68 tasks the AGV 18 with towing the trailer 12 to the loading area 58 and, thereafter, in block 126 with towing the trailer 12 to a staging area. Of course, if the facility 14 did not have products 32 to load onto the trailer 12, the AGV 18 can tow the trailer 12 directly to the staging area in block 128.

In some embodiments, a distribution chain system is described herein that includes a trailer having walls enclosing an interior thereof and at least one wheel assembly. The trailer is configured to releasably couple to a delivery vehicle and an automated ground vehicle (AGV) and contain products. The AGV is configured to autonomously couple to the trailer and transport the trailer. The system further includes a product facility having an associated facility control circuit; a geofencing device of the product facility establishing a boundary therearound; and an electronic assembly of the trailer. The electronic assembly includes: scanning devices disposed within the interior of the trailer and configured to scan and identify products within the interior; a transceiver; and a trailer control circuit configured to operate the scanning devices and the transceiver. The electronic assembly is configured to: detect the boundary of the product facility established by the geofencing device thereof; identify the product facility based on the geofencing device; scan, using the scanning devices, the interior to identify the products therein; determine whether any of the products are intended for delivery to the product facility; and send a signal to the facility control circuit indicating whether the trailer contains products intended for delivery to the product facility. The facility control circuit is configured to dispatch the AGV to couple to the trailer with a task dependent on whether the trailer contains products intended for delivery to the product facility.

By several approaches, the facility control circuit is configured to: task the AGV to tow the trailer to an unloading area in response to receiving the signal from the trailer electronic assembly indicating that the trailer contains products intended for delivery; and task the AGV to tow the trailer to a secondary area in response to receiving the signal from the trailer electronic assembly indicating that the trailer does not contain products intended for delivery.

By further approaches, the facility control circuit configured to task the AGV to tow the trailer to the secondary area includes the facility control circuit configured to task the AGV to tow the trailer to a loading area in response to determining that the product facility has products intended for the trailer.

By further approaches, the facility control circuit configured to task the AGV to tow the trailer to the secondary area includes the facility control circuit configured to task the AGV to tow the trailer to a storage area in response to determining that the trailer does not have a current assignment. By yet further approaches, the walls of the trailer comprise a top wall, a bottom wall, and side walls extending between edges of the top and bottom walls and the trailer further includes: a bracing structure extending across the top wall; an electromagnet mounted to the top wall such that the trailer can be lifted by connection to the electromagnet, the bracing structure preventing deformation of the trailer walls during lifting. By yet further approaches, the product facility further includes a crane in the storage area that is configured to: couple to the electromagnet of the trailer for lifting the trailer; and stack the trailer on a similarly configured trailer for storage.

By some approaches, the trailer further includes a folding leg mechanism having pivoting legs, the folding leg mechanism configured to shift the pivoting legs from a storage position when coupled to a delivery vehicle or AGV to a use position supporting a forward portion of the trailer when the trailer is decoupled from the delivery vehicle or AGV.

By several approaches, the electronic assembly is configured to receive power from the delivery vehicle or AGV when coupled thereto.

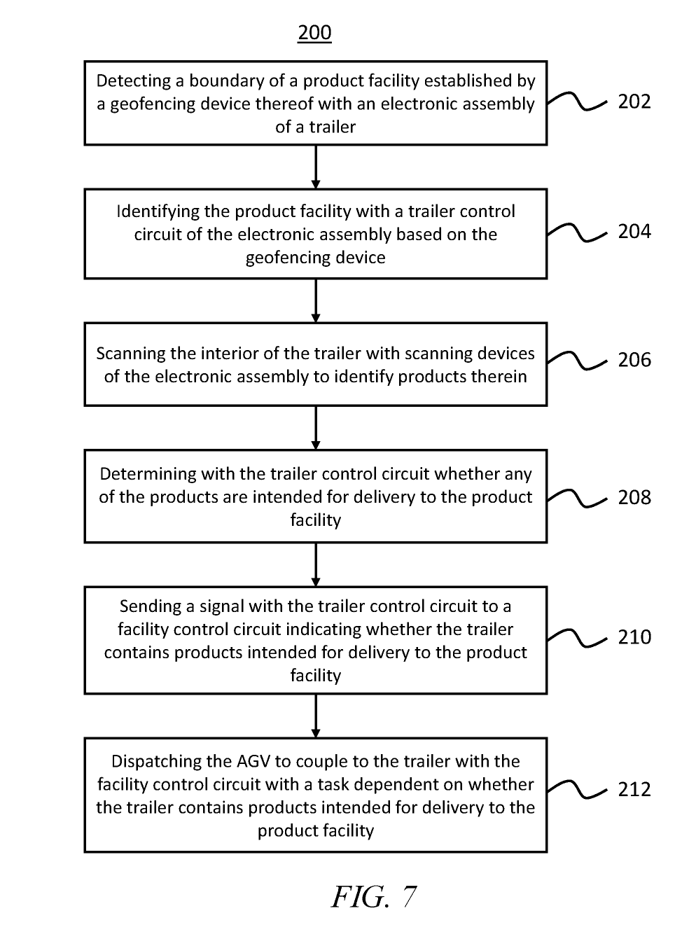

In several embodiments and as shown in FIG. 7, a method 200 for a distribution chain is described herein that includes: detecting 202 a boundary of a product facility established by a geofencing device thereof with an electronic assembly of a trailer, the trailer having walls enclosing an interior thereof and at least one wheel assembly, the trailer configured to releasably couple to a delivery vehicle and an automated ground vehicle (AGV), wherein the trailer is configured to contain products in the interior thereof; and the AGV is configured to autonomously couple to the trailer and transport the trailer; identifying 204 the product facility with a trailer control circuit of the electronic assembly based on the geofencing device; scanning 206 the interior of the trailer with scanning devices of the electronic assembly to identify the products therein; determining 208 with the trailer control circuit whether any of the products are intended for delivery to the product facility; sending 210 a signal with the trailer control circuit to a facility control circuit indicating whether the trailer contains products intended for delivery to the product facility; and dispatching 212 the AGV to couple to the trailer with the facility control circuit with a task dependent on whether the trailer contains products intended for delivery to the product facility.

By some approaches, dispatching 212 the AGV to the trailer with the task can include: dispatching the AGV with a task to tow the trailer to an unloading area in response to receiving the signal from the trailer electronic assembly indicating that the trailer contains products intended for delivery; and dispatching the AGV with a task to tow the trailer to a secondary area in response to receiving the signal from the trailer electronic assembly indicating that the trailer does not contain products intended for delivery.

By further approaches, dispatching 212 the AGV with the task to tow the trailer to the secondary area can include dispatching the AGV with a task to tow the trailer to a loading area in response to determining that the product facility has products intended for the trailer.

By further approaches, dispatching 212 the AGV with the task to tow the trailer to the secondary area can include dispatching the AGV with a task to tow the trailer to a storage area in response to determining that the trailer does not have a current assignment. By yet further approaches, the method 200 can further include: coupling to an electromagnet mounted to a top wall of the trailer with a crane of the storage area; lifting the trailer with the crane; and placing the trailer in a storage position within the storage area. By yet further approaches, placing the trailer in the storage position can include stacking the trailer on a similarly configured trailer for storage.

By several approaches, the method 200 further includes pivoting legs of the trail from a storage position to a use position when the trailer is decoupled from a delivery vehicle or AGV.

By some approaches, the method 200 further includes the electronic assembly receiving power from the delivery vehicle or AGV when the trailer is coupled thereto.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A distribution chain system, the system comprising:
a trailer having walls enclosing an interior thereof and at least one wheel assembly, the trailer configured to releasably couple to a delivery vehicle and an automated ground vehicle (AGV), wherein the trailer is configured to contain products; and the AGV is configured to autonomously couple to the trailer and transport the trailer;
a product facility having an associated facility control circuit;
a geofencing device of the product facility establishing a boundary therearound;
an electronic assembly of the trailer, the electronic assembly comprising:
scanning devices disposed within the interior of the trailer and configured to scan and identify products within the interior;
a transceiver;
a trailer control circuit configured to operate the scanning devices and the transceiver;
wherein electronic assembly is configured to:
detect the boundary of the product facility established by the geofencing device thereof;
identify the product facility based on the geofencing device;
scan, using the scanning devices, the interior to identify the products therein;
determine whether any of the products are intended for delivery to the product facility;
send a signal to the facility control circuit indicating whether the trailer contains products intended for delivery to the product facility;
wherein the facility control circuit is configured to dispatch the AGV to couple to the trailer with a task dependent on whether the trailer contains products intended for delivery to the product facility.

2. The system of claim 1, wherein the facility control circuit configured to dispatch the AGV to the trailer with the task comprises the facility control circuit configured to:
task the AGV to tow the trailer to an unloading area in response to receiving the signal from the trailer electronic assembly indicating that the trailer contains products intended for delivery;
task the AGV to tow the trailer to a secondary area in response to receiving the signal from the trailer electronic assembly indicating that the trailer does not contain products intended for delivery.

3. The system of claim 2, wherein the facility control circuit configured to task the AGV to tow the trailer to the secondary area comprises the facility control circuit configured to task the AGV to tow the trailer to a loading area in response to determining that the product facility has products intended for the trailer.

4. The system of claim 2, wherein the facility control circuit configured to task the AGV to tow the trailer to the secondary area comprises the facility control circuit configured to task the AGV to tow the trailer to a storage area in response to determining that the trailer does not have a current assignment.

5. The system of claim 4, wherein the walls of the trailer comprise a top wall, a bottom wall, and side walls extending between edges of the top and bottom walls, the trailer further comprising:
a bracing structure extending across the top wall;
an electromagnet mounted to the top wall such that the trailer can be lifted by connection to the electromagnet, the bracing structure preventing deformation of the trailer walls during lifting.

6. The system of claim 5, wherein the electromagnet is spaced from the edges of the top wall.

7. The system of claim 5, wherein the product facility further comprises a crane in the storage area, the crane being configured to:
couple to the electromagnet of the trailer for lifting the trailer; and
stack the trailer on a similarly configured trailer for storage.

8. The system of claim 1, wherein the trailer further comprises a folding leg mechanism having pivoting legs, the folding leg mechanism configured to shift the pivoting legs from a storage position when coupled to a delivery vehicle or AGV to a use position supporting a forward portion of the trailer when the trailer is decoupled from the delivery vehicle or AGV.

9. The system of claim 8, wherein the folding leg mechanism is spring loaded such that when the delivery vehicle or AGV decouples from the trailer, the pivoting legs are driven to the use position.

10. The system of claim 1, wherein the electronic assembly comprises multiple scanners disposed along a length of the interior of the trailer.

11. The system of claim 1, wherein the electronic assembly is configured to receive power from the delivery vehicle or AGV when coupled thereto.

12. A method for a distribution chain, the method comprising:
detecting a boundary of a product facility established by a geofencing device thereof with an electronic assembly of a trailer, the trailer having walls enclosing an interior thereof and at least one wheel assembly, the trailer configured to releasably couple to a delivery vehicle and an automated ground vehicle (AGV), wherein the trailer is configured to contain products in the interior thereof; and the AGV is configured to autonomously couple to the trailer and transport the trailer;
identifying the product facility with a trailer control circuit of the electronic assembly based on the geofencing device;
scanning the interior of the trailer with scanning devices of the electronic assembly to identify the products therein;
determining with the trailer control circuit whether any of the products are intended for delivery to the product facility;
sending a signal with the trailer control circuit to a facility control circuit indicating whether the trailer contains products intended for delivery to the product facility;
dispatching the AGV to couple to the trailer with the facility control circuit with a task dependent on whether the trailer contains products intended for delivery to the product facility.

13. The method of claim 12, wherein dispatching the AGV to the trailer with the task comprises:
dispatching the AGV with a task to tow the trailer to an unloading area in response to receiving the signal from the trailer electronic assembly indicating that the trailer contains products intended for delivery;
dispatching the AGV with a task to tow the trailer to a secondary area in response to receiving the signal from the trailer electronic assembly indicating that the trailer does not contain products intended for delivery.

14. The method of claim 13, wherein dispatching the AGV with the task to tow the trailer to the secondary area comprises dispatching the AGV with a task to tow the trailer to a loading area in response to determining that the product facility has products intended for the trailer.

15. The method of claim 13, wherein dispatching the AGV with the task to tow the trailer to the secondary area comprises dispatching the AGV with a task to tow the trailer to a storage area in response to determining that the trailer does not have a current assignment.

16. The method of claim 15, further comprising:
coupling to an electromagnet mounted to a top wall of the trailer with a crane of the storage area;
lifting the trailer with the crane;
placing the trailer in a storage position within the storage area.

17. The method of claim 16, wherein placing the trailer in the storage position comprises stacking the trailer on a similarly configured trailer for storage.

18. The method of claim 12, further comprising pivoting legs of the trailer from a storage position to a use position when the trailer is decoupled from a delivery vehicle or AGV.

19. The method of claim 12, further comprising the electronic assembly receiving power from the delivery vehicle or AGV when the trailer is coupled thereto.
